(19) United States
(12) Patent Application Publication
(10) Pub. No.: US 2005/0071151 A1
(43) Pub. Date: Mar. 31, 2005

(54) Compression-decompression mechanism

(76) Inventors: Ali-Reza Adl-Tabatabai, Santa Clara, CA (US); Anwar M. Ghuloum, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/676,430

(22) Filed: Sep. 30, 2003

(51) Int. Cl. G06F 17/21

(52) U.S. Cl. 704/10

(57) ABSTRACT

According to one embodiment a method is disclosed. The method includes receiving a string of data symbols, and compressing the string of symbols into a compressed data block having a plurality of compressed symbols and dictionary elements. The compressed data block has a fixed offset and the symbols and dictionary elements have a fixed length.

### FIELD OF THE INVENTION

The present invention relates to computer systems; more particularly, the present invention relates to compressing data within a computer system.

### BACKGROUND

Currently, various mechanisms are employed to compress data in computer systems. Such methods include adaptive dictionary based algorithms. Dictionary based algorithms feature scanning a data block to be compressed in order to find frequently used values (or redundancies). The redundancies are replaced in the data block with pointers to various locations within a dictionary table, where the value is stored. The dictionary and the compressed data block are subsequently transmitted. Once received the data block is decompressed by reinserting the redundant values in place of the pointers.

Existing dictionary-based compression methods (such as X-Match, Wilson-Kaplan and the LZ variants) serially decompress each symbol in a compressed block. Thus, random access into the compressed block is precluded. The additional latency due to serial access makes existing dictionary-based compression methods undesirable for latency-sensitive applications that require fast random access.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a computer system;

FIG. 2 illustrates one embodiment of a compressed data block format;

FIG. 3 is a block diagram illustrating one embodiment of a cache controller;

FIG. 4 illustrates one embodiment of a compression data path;

FIG. 5 illustrates one embodiment of compression logic;

FIG. 6 illustrates another embodiment of compression logic;

FIG. 7 illustrates another embodiment of compression logic;

FIG. 8 illustrates one embodiment of decompression logic; and

FIG. 9 illustrates one embodiment of logic for a decompression unit.

### DETAILED DESCRIPTION

A compression-decompression mechanism is described. In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

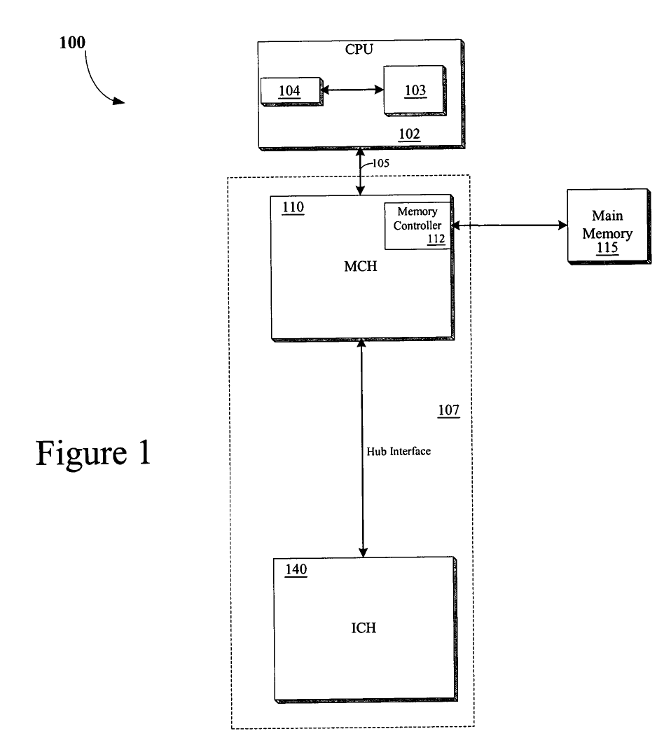

FIG. 1 is a block diagram of one embodiment of a computer system 100. Computer system 100 includes a central processing unit (CPU) 102 coupled to bus 105. In one embodiment, CPU 102 is a processor in the Pentium® family of processors including the Pentium® II processor family, Pentium® III processors, and Pentium® IV processors available from Intel Corporation of Santa Clara, Calif. Alternatively, other CPUs may be used.

A chipset 107 is also coupled to bus 105. Chipset 107 includes a memory control hub (MCH) 110. MCH 110 may include a memory controller 112 that is coupled to a main system memory 115. Main system memory 115 stores data and sequences of instructions and code represented by data signals that may be executed by CPU 102 or any other device included in system 100.

In one embodiment, main system memory 115 includes dynamic random access memory (DRAM); however, main system memory 115 may be implemented using other memory types. Additional devices may also be coupled to bus 105, such as multiple CPUs and/or multiple system memories.

In one embodiment, MCH 110 is coupled to an input/output control hub (ICH) 140 via a hub interface. ICH 140 provides an interface to input/output (I/O) devices within computer system 100. For instance, ICH 140 may be coupled to a Peripheral Component Interconnect bus adhering to a Specification Revision 2.1 bus developed by the PCI Special Interest Group of Portland, Oreg.

According to one embodiment, a cache memory 103 resides within processor 102 and stores data signals that are also stored in memory 115. Cache 103 speeds up memory accesses by processor 102 by taking advantage of its locality of access. In another embodiment, cache 103 resides external to processor 103.

According to a further embodiment, cache 103 includes compressed cache lines to enable the storage of additional data within the same amount of area. In such an embodiment, the cache lines are compressed via a Parallel Dictionary Decompression (PDD) compression mechanism.

In one embodiment, PDD is effective on program heap data and on small block sizes (e.g., 64-128 bytes) by taking advantage of redundancies typically found in program data (e.g., redundancies in the upper bits of pointers and small integer values). PDD compresses a fixed-size block of data serially (e.g., one 4-byte dword or 8-byte chunk per clock).

The result of compressing a block is a fixed-size compressed block with a size that depends on the compression ratio. In one embodiment, a compressed block includes a fixed number of compressed symbols (each of which is a compressed representation of a 32-bit word in the uncompressed block) and a fixed number of dictionary elements.

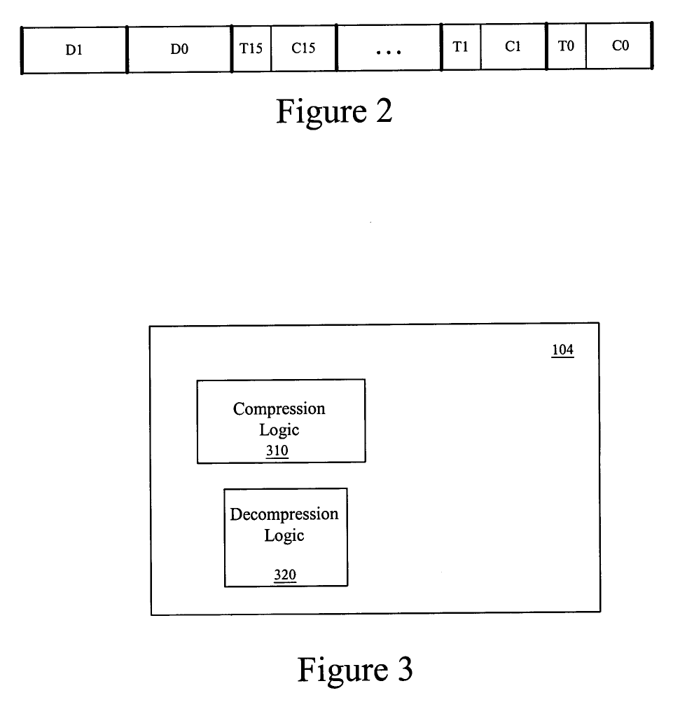

FIG. 2 illustrates one embodiment of a PDD compressed data block format. The compressed block includes two dictionary elements (D0 and D1) and 16 compressed symbols (unmatched bits C0-C15 and tags T0-T15). To enable parallel decompression, PDD compresses blocks such that dictionary elements and compressed symbols are a fixed length and at a fixed offset within the compressed block.

Tags within a compressed symbol indicate a type of decompression being used. Table 1 shows an example encoding for the tags in the compressed block illustrated in FIG. 2. A 2-bit tag Ti encodes 4 possible ways in which the corresponding ith symbol is decompressed.

If Ti=00, a 0-extension of the unmatched bits Ci occurs. For example, if T15 is 0 and C15 is 1, the first word is 1, which is preceded by all zeroes. If Ti=01, a 1-extension of the unmatched bits Ci occurs. For example, if T15 and C15 is 1, the first word has a negative value (depending on the width of C), which is preceded by all ones. If Ti=10, the unmatched bits Ci are appended to the bits of dictionary element D0. Similarly, if Ti=11, the unmatched bits Ci are appended to the dictionary element D1.

TABLE 1

| Ti | Decompression method |
|---|---|
| 00 | 0 extend unmatched bits |
| 01 | 1 extend unmatched bits |
| 10 | Append unmatched bits to D0 |
| 11 | Append unmatched bits to D1 |

In contrast to existing compression mechanisms, which have a variable compression ratio to compress by as much as possible, PDD has a fixed compression ratio. fixed compression ratio suits applications that manage memory fixed in chunks and require fast decompression latency. For instance, cache memory is organized and managed in 64 or 128-byte sectors so that variable decompression ratio leads to fragmentation (e.g., unused space in the compressed block). Although described with reference to a cache compression application, one of ordinary skill in the art will appreciate that the PDD compression mechanism may be implemented in other applications (e.g., such as memory and bus compression, and network packet compression).

The compression ratio of PDD depends on several design parameters including the size of the block being compressed, the number of dictionary elements, and the size of each dictionary element. The design parameters can be tuned to meet the compression ratio requirements of the target application for which compression is being used, and to maximize the number of blocks compressed in the target workloads.

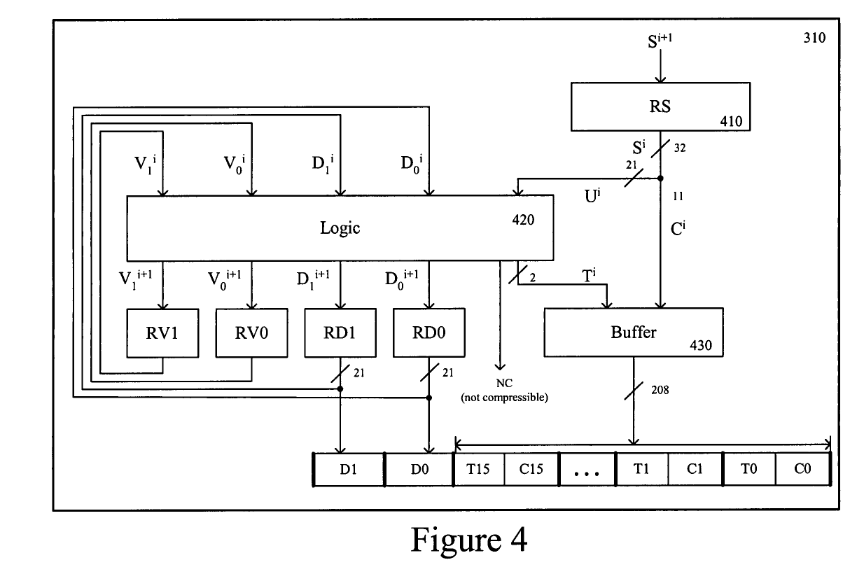

FIG. 3 illustrates one embodiment of cache controller 104. Cache controller 104 includes compression logic 310 and decompression logic 320. Compression logic 310 implements the PDD mechanism to compress data blocks. FIG. 4 illustrates one embodiment of a compression data path. The compression data path includes registers (RS), logic 420 and buffer 430.

According to one embodiment, PDD compresses one 32-bit symbol per clock cycle. At iteration i, the ith symbol Sⁱ (held in register RS) is split into its upper 21 bits (signal Uⁱ) and its bottom 11 bits (the unmatched bits Cⁱ). Uⁱ is compressed into a tag Tⁱ, which is accumulated along with Cⁱ in a buffer. Registers RD0 and RD1 hold the two dictionary elements and registers RV0 and RV1 are Booleans that indicate whether RD0 and RD1 hold valid dictionary elements, respectively.

At iteration i, signal Dⱼⁱ is the value of dictionary element RDj and is valid only if signal Vⱼⁱ is true. The initial value of RVj is false, and the initial value of RDj is zero. At each iteration i, logic 420 takes as input the dictionary values Dⱼⁱ, dictionary valid bits Vⱼⁱ, and upper bits of the symbol Uⁱ, and produces the tag Tⁱ for the current iteration as well as the dictionary values Dⱼⁱ⁺¹ and valid bits Vⱼⁱ⁺¹ for the next iteration (i.e., iteration i+1).

In one embodiment, the RV and RD registers load new values upon each iteration. The not compressible signal (NC) is set to true, if Uⁱ is not compressible (e.g., Uⁱ cannot be compressed via sign extension, it does not match any values in the dictionary elements, and the dictionary elements are all valid).

After 16 iterations, the buffer holds the 16 compressed symbols (208 bits of data), and the dictionary registers, RD0 and RD1, hold the dictionary elements. The dictionary registers and buffer 430 are combined to form the compressed block, regardless of the values in RV0 and RV1 (sometimes dictionary elements are unused in a compressed block, indicated by a false value in RV0 or RV1).

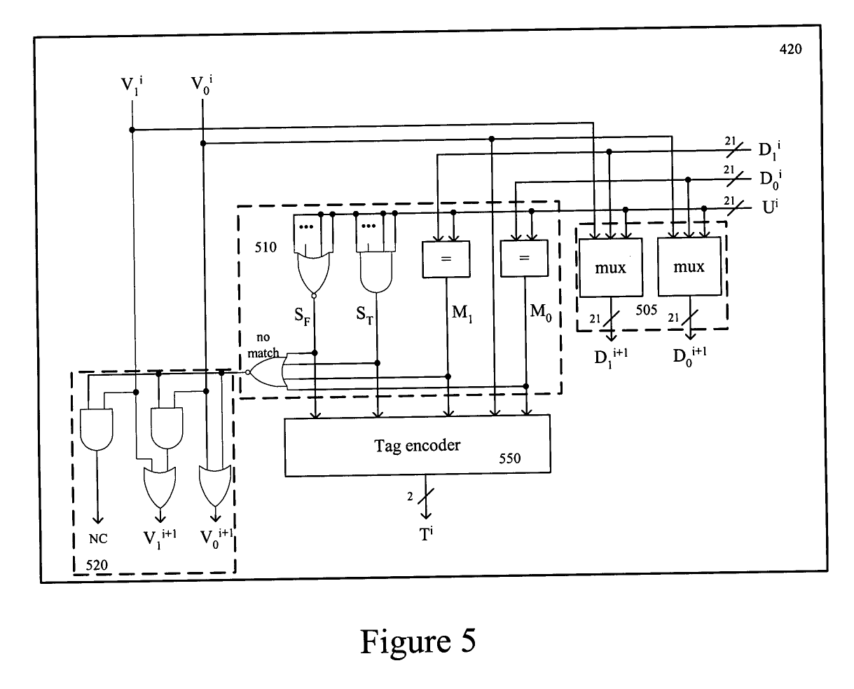

FIG. 5 illustrates one embodiment of logic 420. Logic 420 includes dictionary comparison logic 505, match logic 510, no match logic 520 and tag encoder 550. Match logic 510 determines if there is a match, resulting in successful compression for a particular iteration. For instance the upper 21 bits of word are compared against each dictionary at dictionary comparison logic 505. If there is a match, tag encoder compresses the data, as will be described below.

The and-gate and nor-gate in logic 510 determine whether the bits are all ones, or all zeroes, respectively. If all ones, the data is compressed via one extension. If all zeroes, the data is compressed via zero extension. If the bits are not all ones, all zeroes, or do not match any of the dictionary elements, a no match signal is transmitted to no match logic 520. No match logic 520 is used to store the unmatched bits in the next dictionary entry. One of ordinary skill in the art will appreciate that other types of logic circuitry may be used to implement the components of logic 420.

Tag encoder 550 uses the match, sign-extension, and valid signals to generate the tag value according to the encoding of Table 1. Table 2 shows a truth table for tag encoder 550.

TABLE 2

| S_{F} | S_{T} | M₀ | M₁ | V₀ | T₁ | T₀ | |
|---|---|---|---|---|---|---|---|
| 1 | — | — | — | — | 0 | 0 | 0-extend |
| — | 1 | — | — | — | 0 | 1 | 1-extend |
| 0 | 0 | 1 | — | — | 1 | 0 | D0 |
| 0 | 0 | 0 | 1 | — | 1 | 1 | D1 |
| 0 | 0 | 0 | 0 | 0 | 1 | 0 | D0 |
| 0 | 0 | 0 | 0 | 1 | 1 | 1 | D1 |

In one embodiment, the critical path in FIG. 5 can be reduced by performing tag encoding in a separate pipeline stage (removing it altogether from the critical path), and by overlapping generation of the previous iteration's valid bits with the matching logic (which makes the critical path be the maximum of either the match logic delay or the generation of the valid bits).

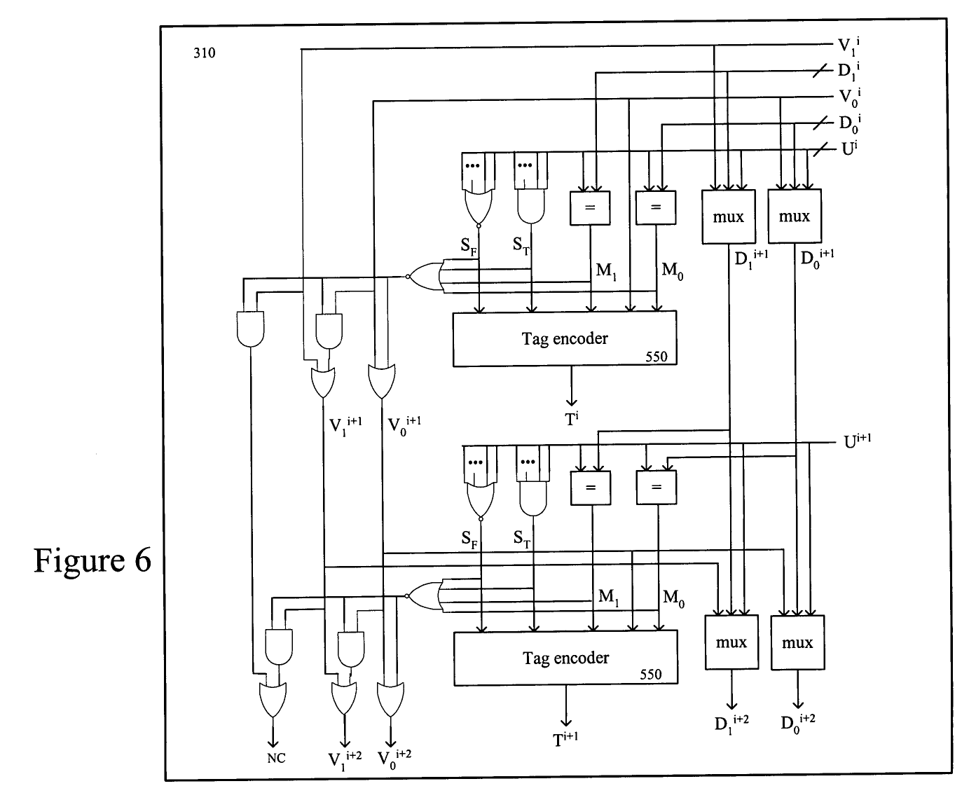

FIG. 5 illustrates compressing one 32-bit symbol per clock cycle. However in other embodiments, more than one, for example, two 32-bit symbols (a “chunk”) compressed at a time, allowing data that arrives over an 8-byte bus be compressed as it arrives. FIG. 6 illustrates another embodiment of logic 420 for compressing a chunk at a time.

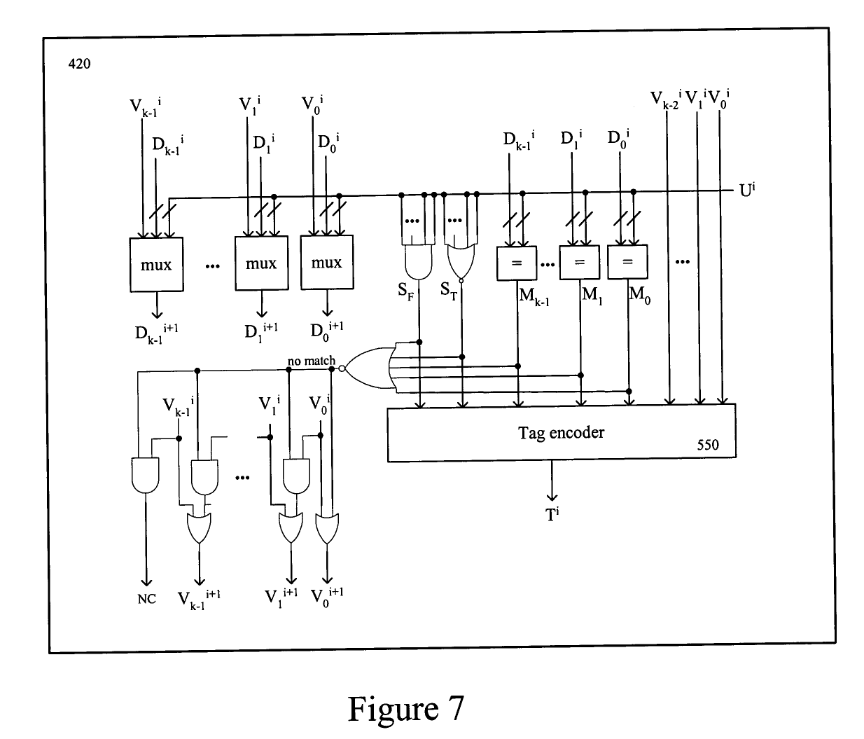

In one embodiment, the number of dictionary elements may be varied. FIG. 7 illustrates one embodiment of logic 420 implementing k dictionary elements. In one embodiment, the number of dictionary elements (N_{D}) is quantitatively related to several parameters such as a number of leading bits matched (L), block size (B) in bits, size of compression tags (T) and word size (W). In a further embodiment, the number of leading bits can be calculated based upon the following equations:

$$\begin{matrix}L * {N}_{D} + \frac{B}{W} * ( T + ( W - L ) + ⌈ {log}_{2} {N}_{D} ⌉ ) \leq \frac{B}{2} if {N}_{D} > 1 ; and \\ L * {N}_{D} + \frac{B}{W} * ( T + ( W - L ) ) \leq \frac{B}{2} if {N}_{D} \leq 1\end{matrix}$$

Therefore, using PDD enables picking a fixed number of leading bits to match and automatically derive the number of dictionary elements available. In another embodiment, the number of desired dictionary elements can be fixed in order to solve for the leading bits allowed in partial matches and sign extension.

According to other embodiments, the format of a compressed block can also be varied. For example, the dictionary elements can be placed in the middle of the compressed block or at either ends of the compressed block. If the compressed block is transmitted serially over a bus, then placing the dictionary elements at the beginning of the compressed block allows decompression to be overlapped with arrival of the compressed data.

If the compressed block is available in parallel, then placing the dictionary elements in the middle of the block minimizes delays in distributing the elements to the decompression units. In a further embodiment, the dictionary elements may be replicated throughout the compressed block. Replicating the dictionary elements to provide efficient access to all segments of the block.

In another embodiment, different methods of combining unmatched bits with dictionary elements may be implemented, as well as different methods of sign-extending unmatched bits to handle data types such as packed 8 or 16-bit integers, unicode characters (Utf16), aligned pointers, and floating point. For example, the compression logic can divide a 32-bit dword into 216-bit halves and compress each half's leading sign bits. Compression can also be combined with power optimizations by inverting the dictionary elements and unmatched bits to maximize zeroes. The inversion can be encoded in the tags.

Referring back to FIG. 3, decompression logic 320 decompresses a data block once the block is received at its destination. In one embodiment, decompressor 320 implements PDD to decompress symbols in a compressed block in parallel. To decompress a symbol, PDD either sign-extends its unmatched bits or combines its unmatched bits with the bits in one of the dictionary elements. A symbol's tag indicates whether the symbol's unmatched bits should be sign-extended or combined with a dictionary element. If the symbol is to be combined with a dictionary element, the tag indicates the index of the dictionary element as well as how the unmatched bits and dictionary element are combined.

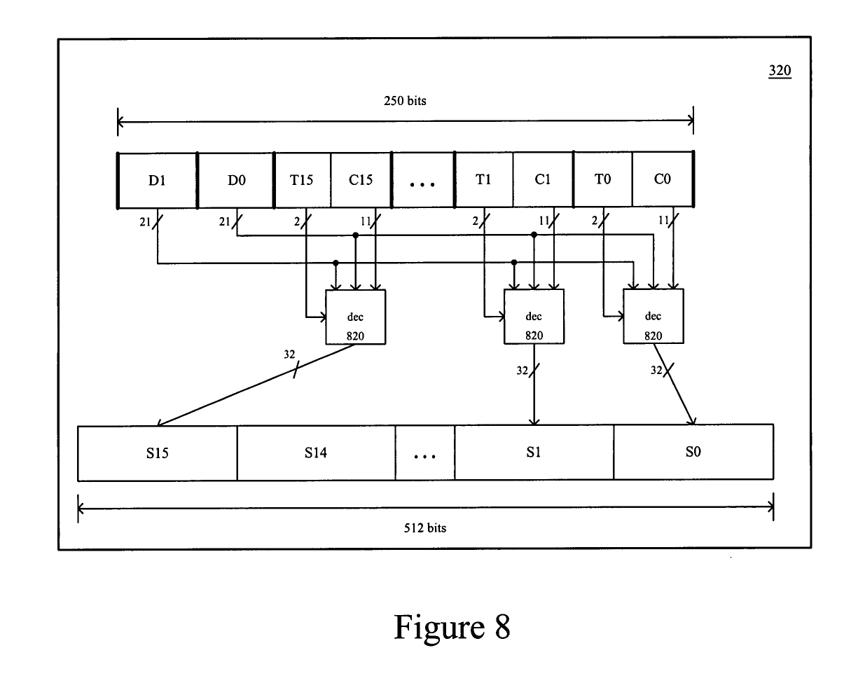

FIG. 8 illustrates one embodiment of decompression logic 320. Decompression logic 320 includes a decompression units 820 associated with each compressed symbol. The decompression units 820 operate in parallel. Each decompression unit 820 takes as input a compressed symbol (Ti and Ci), and the two dictionary elements D0 and D1, and produces as output a 32-bit decompressed symbol Si.

The latency to produce a decompressed symbol Si equals the delay to distribute the dictionary elements D0 and D1 to Si's decompression unit, plus the latency of the decompression unit. In one embodiment, unmatched bits are each 11 bits; therefore, dictionary elements are each 21 bits, and the compressed block is 250 bits. The decompressed block is 512 bits for a compression ratio of slightly better than 2:1. Thus, such an embodiment is suitable for compressing 64 byte data, such as cache lines, down to 32 bytes. However, one of ordinary skill in the art will appreciate that other size data blocks, dictionary elements and compression ratios may be implemented without departing from the true scope of the invention.

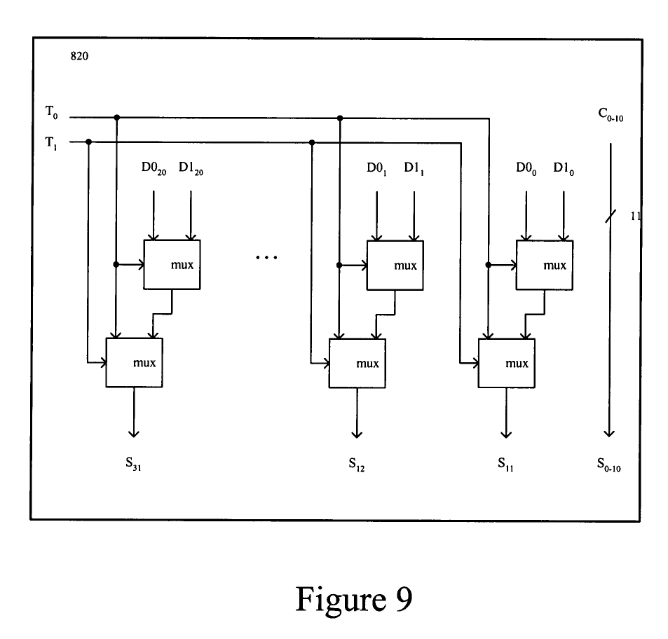

FIG. 9 illustrates one embodiment of logic for a decompression unit 820. The unmatched bits are passed through to form the least significant 11 bits of the uncompressed symbol. Decompression unit 820 implements 2 levels of 2-input multiplexers wherein the tag bits select the most significant 21 bits of the uncompressed symbol according to the encoding shown above in Table 1.

The PDD mechanism enables dictionary based data blocks to be decompressed in parallel, thus various data within the block may be randomly decompressed and access without having to wait for the entire block to be decompressed. Accordingly, latency-sensitive applications, such as cache line compression, may implement PDD without incurring performance losses.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

1. A method comprising:
receiving a string of data symbols; and
compressing the string of data into a fixed sized compressed data block having a plurality of compressed symbols and dictionary elements, the symbols and dictionary elements having a fixed length and a fixed offset.

2. The method of claim 1 wherein compressing the data comprises:
dividing a first symbol into a first component and a second component; and
comparing the first component with the dictionary elements.

3. The method of claim 2 further comprising compressing the first component to form a first tag if the first component matches a dictionary element.

4. The method of claim 3 wherein each symbol includes a tag to indicate a compression type.

5. The method of claim 3 further comprising storing the first component at a dictionary element if the first component does not match a dictionary element.

6. The method of claim 3 wherein compressing the data comprises:
dividing a second symbol into a second component and a second component; and
comparing the second component with the dictionary elements.

7. A compression system:
a register to store a plurality of fixed length data symbols to be compressed;
compression logic to compress each of the plurality of data symbols to form a compressed symbol, the compressed symbols forming a compressed data block having a fixed offset; and
a plurality of dictionary registers to store dictionary elements having a fixed length.

8. The system of claim 7 wherein each symbol is divided into a first component and a second component.

9. The method of claim 8 wherein the first and second components are compressed into fixed length tags.

10. The method of claim 8 wherein the first and second components are compressed into variable length tags.

11. The system of claim 8 wherein the first component is received at the compression logic and encoded to form a tag.

12. The system of claim 11 further comprising a buffer to store the tag and second component of each symbol as the compressed symbol.

13. The system of claim 8 wherein the compression logic comprises:
dictionary matching logic to determine if the first component matches a dictionary element; and
constant match logic to determine if the second component has all ones or all zeroes.

14. The system of claim 13 wherein the compression logic comprises an encoder coupled to the match logic and the no match logic to encode the first component to form a tag if the first component matches a dictionary element, has all ones or zeroes.

15. A method comprising:
receiving a fixed offset compressed data block having a plurality of dictionary elements and compressed symbols; and
decompressing each of the compressed symbols in parallel.

16. The method of claim 15 wherein each of the compressed symbols are decompressed simultaneously.

17. The method of claim 15 wherein decompressing each of the compressed symbols comprises:
analyzing a tag component within a compressed symbol; and
decompressing the compressed symbol to form a symbol based upon the tag value.

18. The method of claim 17 wherein decompressing the compressed symbol to form a symbol based upon the tag value comprises:
decoding the tag to form a matched component of the symbol; and
combining the matched component with an unmatched component within the compressed symbol to form the symbol.

19. A decompression system comprising:
a plurality of decompression units to decompress a corresponding compressed symbol within a compressed data block to generate an uncompressed symbol, wherein the decompression units decompress the compressed symbols in parallel.

20. The system of claim 19 wherein the compressed symbol comprises a tag component and an unmatched symbol component.

21. The system of claim 20 wherein each decompression unit comprises logic to decode the tag component of a compressed symbol to generate a matched symbol component.

22. The system of claim 21 wherein each decompression unit combines a matched symbol component with the unmatched symbol component to form an uncompressed symbol.

23. A computer system comprising:
a central processing unit (CPU);
a cache memory coupled to the CPU having a plurality of compressible cache lines to store additional data; and
a cache controller comprising compression logic to compress each of the plurality of cache lines by compressing the data within a compressed cache line into a fixed sized compressed data block having a plurality of offset compressed symbols and dictionary elements, the symbols and dictionary elements having a fixed length and fixed offset.

24. The computer system of claim 23 wherein the cache controller further comprises decompression logic to decompress compressed symbols within a compressed data block to generate uncompressed symbols.

25. The computer system of claim 24 wherein the decompression logic decompresses the compressed symbols in parallel.

26. A computer system comprising:
a central processing unit (CPU);
a cache memory coupled to the CPU having a plurality of compressible cache lines to store additional data;
a chipset, coupled to the CPU and the cache memory, including:
compression logic to compress each of the plurality of cache lines by compressing the data within a compressed cache line into a fixed sized compressed data block having a plurality of offset compressed symbols and dictionary elements, the symbols and dictionary elements having a fixed length and fixed offset; and
a main memory coupled to the chipset;

27. The computer system of claim 26 wherein the chipset further comprises decompression logic to decompress compressed symbols within a compressed data block to generate uncompressed symbols.

28. A method comprising:
receiving a fixed offset compressed data block having a plurality of dictionary elements and compressed symbols; and
decompressing a randomly accessed and a first compressed symbol within the compressed data block.

29. The method of claim 28 wherein decompressing the first compressed symbol comprises:
analyzing a tag component within a compressed symbol; and
decompressing the compressed symbol to form a symbol based upon the tag value.
